(19) United States
(12) Patent Application Publication
(10) Pub. No.: US 2026/0296153 A1
(43) Pub. Date: Oct. 1, 2026

(54) TONNEAU COVER

(71) Applicant: Worksport Ltd., Vaughan (CA)

(72) Inventor: James G. Quintus, Nixa, MO (US)

(73) Assignee: Worksport Ltd., Vaughan, ON (CA)

(21) Appl. No.: 19/479,107

(22) PCT Filed: Apr. 27, 2024
(86) PCT No.: PCT/US2024/026696

§ 371 Date: Oct. 27, 2025

(51) Int. Cl. B60J 7/14; B60J 7/19

(52) U.S. Cl. CPC B60J 7/141; B60J 7/198

(57) ABSTRACT

A foldable tonneau cover for use in covering the bed of a pickup truck. The tonneau cover includes a plurality of sections or panels and a hinge assembly that hingedly connects the panels whereby the panels are foldable relative to one another to form a stack. The hinge assembly includes a flexible hinge and at least one hinge clip that is in a positive locking retained engagement with a panel and that secures the flexible hinge to the panel. The panels are rigid and include a central panel, defining a perimeter, and a plurality of reinforcement members. The reinforcement members are located along the perimeter of the central panel and are engaged with the central panel in a press-fit mechanical locking engagement.

### BACKGROUND

### 1. Field of the Invention

The present invention generally relates to tonneau covers used in covering the cargo boxes of pickup trucks. More specifically, the present invention relates to the construction of various aspects of such tonneau covers.

### 2. Description of Related Art

One advantage of a pickup truck (hereafter the “truck”) is the ability to use the bed of the truck to transport cargo that might not otherwise be suitable for transporting in other vehicles, for example, oversized items, like a large television, or items that might soil the interior of the vehicle, like garden supplies. The bed commonly includes a pair of opposed sidewalls joined at their forward and rearward ends by a front wall or bulkhead and rear wall or tailgate, respectively.

One accessory that exists to cover the bed of the truck is commonly referred to as a tonneau cover. Tonneau covers are used to cover the beds of pickup trucks for multiple reasons, including aesthetics, aerodynamics, and protection of any contents located in the bed, both from ejection and from environmental factors, such as rain, dirt, snow, and debris.

While various styles of tonneau covers exist, one popular style of tonneau cover is a hard, folding tonneau cover.

A hard, folding tonneau cover typically include a series of rigid panel sections that extend laterally across the width of the bed. Each panel section is connected to the adjacent panel section(s) by a hinge mechanism that also extends transversely across the width of the bed. When not required to cover the entire bed of the pickup truck, the panel sections may be successively folded one atop another, from the tailgate toward the bulkhead, into a nested stack leaving at least a portion of the bed open and uncovered.

One drawback of conventional tonneau covers is that the hinge mechanism is complicated in its construction and labor intensive to install. These hinge mechanisms require an elongate hinge member to be slid through a T- or H-shaped slot defined in a hinge extrusion provided on the end of the panel section. Since the hinge mechanism extends across the entire width of the tonneau cover, the hinge member must be progressively slid into the slot across the entire width of the tonneau cover. This process can be difficult and time consuming and is typically not waterproof.

Also, the hinge extrusion must be connected to a panel member. Bolts, rivets, adhesives or other fasteners are typically used to secure together the hinge extrusion and panel member. Not only is this construction time consuming, it requires creation of a penetration (a hole) in the extrusion and panel member, which in turn creates a potential pathway for the infiltration of water.

### SUMMARY

In satisfying the above need, as well as overcoming the enumerated drawbacks and other limitations of the related art, a novel construction for a hinge mechanism of a tonneau cover is provided.

In another aspect, a novel construction for the connection of a hinge extrusion to a panel member is provided.

In one aspect of the invention, a foldable tonneau cover for use in covering the bed of a pickup truck is provided. The tonneau cover typically includes a plurality of tonneau cover sections and also includes a first tonneau cover section and a second tonneau cover section; a hinge assembly including a flexible hinge and at least one hinge clip with the hinge clip being in a positive locking retained engagement with one of the first and second tonneau cover sections and securing the flexible hinge to said one of the first and second tonneau cover sections; and the hinge assembly hingedly connecting the first tonneau cover section to the second tonneau cover section, whereby the first tonneau cover section is foldable relative to the second tonneau cover section so as to form a stack with the first tonneau cover section being located on top of the second tonneau cover section

In another aspect, the hinge clip captively secures the flexible hinge to said one of the first and second tonneau cover sections.

In a further aspect, the flexible hinge includes a body and at least one retention feature, the retention feature being captively secured by the hinge clip to said one of the first and second tonneau cover sections spaced apart from the body.

In an additional aspect, the flexible hinge is of a unitary construction with the retention feature being connected to the body by a web having a reduced cross-sectional thickness relative to the body and the retention feature.

In another aspect, the first and second tonneau cover sections include reinforcement members provided along an end thereof, each the reinforcement members defining a retention groove in which a portion of the flexible hinge is received, whereby the reinforcement members are connected to the hinge assembly.

In a further aspect, the reinforcement members are extrusions.

The foldable tonneau cover according to claim 5, wherein the hinge clip is in positive locking retained engagement with the reinforcement member.

In an additional aspect, the hinge clip is pivotable about a first end into the positive locking retained engagement with said one of the first and second tonneau cover sections.

In another aspect, the positive locking retained engagement of the hinge clip with said one of the first and second tonneau cover sections includes a locking tab of the hinge clip in a snap-in engagement with said one of the first and second tonneau cover sections.

In an additional aspect, the hinge clip includes a free end overlying a portion of the flexible hinge and captively securing the flexible hinge to said one of the first and second tonneau cover sections.

In a further aspect of the invention, a tonneau cover for use with the bed of a pickup truck is provided, the tonneau cover comprising at least one rigid panel, the rigid panel including a central panel member defining a perimeter and a plurality of reinforcement members, the reinforcement members being located along at least a portion of the perimeter of the central panel member, the reinforcement members being engaged with the central panel member in a press-fit mechanical locking engagement.

In another aspect, each of the reinforcement members defines an open ended channel within which the central panel member is received.

In a further aspect, each of the reinforcement members includes opposed and spaced apart upper and lower legs, at one end the upper and lower legs are connected by an end wall and an opposing end the upper and lower legs define an opening into the opened ended channel of the reinforcement member.

In an additional aspect, one of the upper and lower legs include a locking tab, the locking tab being provided on a surface opposing the other of the upper and lower legs.

In another aspect, the locking tab is defined by a ramped lead-in surface followed by an abutment shoulder, whereby the locking tab is in engagement with the central panel member and forms the locking engagement between the reinforcement member and the central panel member.

In a further aspect, the central panel member includes a portion defining an edge facing in a direction away from the reinforcement member, the locking tab being in engagement with the edge.

In another aspect, the reinforcement members are constructed as extrusions.

In a further aspect, at least a portion of the perimeter of the central panel includes a returnly bent portion generally defining a C-shape, the returnly bent portion being formed by a portion of a body defining an upper surface of the central panel member, a transverse leg extending away from the upper surface and a terminal leg extending away from the transverse leg.

In an additional aspect, the terminal leg is in engagement with the reinforcing member thereby forming the locking engagement.

In another aspect, the terminal leg resiliently extends at an angle away from a plane defined by the upper surface and is deflected during engagement with the reinforcing member thereby forming the press-fit mechanical locking engagement.

Further objects, features and advantages of this invention will become readily apparent to persons skilled in the art after review of the following description, including the claims, and with reference to the drawings that are appended to and form a part of this specification.

### BRIEF DESCRIPTION OF THE DRAWINGS

For a fuller understanding of the invention, reference should be made to the following detailed description, taken in connection with the accompanying drawings, in which:

FIG. 1 is a top perspective view of an exemplary embodiment of a tonneau cover in accordance with the present disclosure and shown in an extended position, as would be used to cover the bed of a pickup truck.

FIG. 2 is a top plan view of the tonneau cover seen in FIG. 1.

FIG. 3 is a cross-sectional view, generally taken along line 3-3 in FIG. 2.

FIG. 4 is a cross-sectional view generally taken along line 3-3 within a process of folding one panel on top of an adjacent panel.

FIG. 5 is an enlarged view of the portion of the tonneau cover generally encircled by line 5-5 in FIG. 3.

### DETAILED DESCRIPTION

In the following detailed description of the embodiments, reference is made to the accompanying drawings, which form a part thereof, and within which are shown by way of illustration of specific embodiments by which the invention may be practiced. It is to be understood that other embodiments may be utilized and structural changes may be made without departing from the scope of the invention. It should be further noted that while the drawings illustrate a foldable, hard tonneau cover, embodiments of the current invention can be utilized with any style of foldable tonneau cover, as aspects of the invention relates to the hinge assembly and/or frame assembly of such a tonneau cover.

As used in the description that follows, directional terms such as “upper” and “lower” are used with reference to the orientation of the elements as presented in the figures. Accordingly, “upper” indicates a direction toward the top of the figure and “lower” indicates a direction toward the bottom of the figure. The terms “left” and “right” are similarly interpreted. The terms “inward” or “inner” and “outward” or “outer” indicate a direction that is generally toward or away from a central axis of the referred to part, whether or not such an axis is designated in the figures. An axial surface is therefore one that faces in the axial direction. In other words, an axial surface faces in a direction along the central axis. A radial surface therefore faces radially, generally away from or toward the central axis. It will be understood, however, that in actual implementation, the directional references used herein may not necessarily correspond with the installation and orientation of the corresponding components or device.

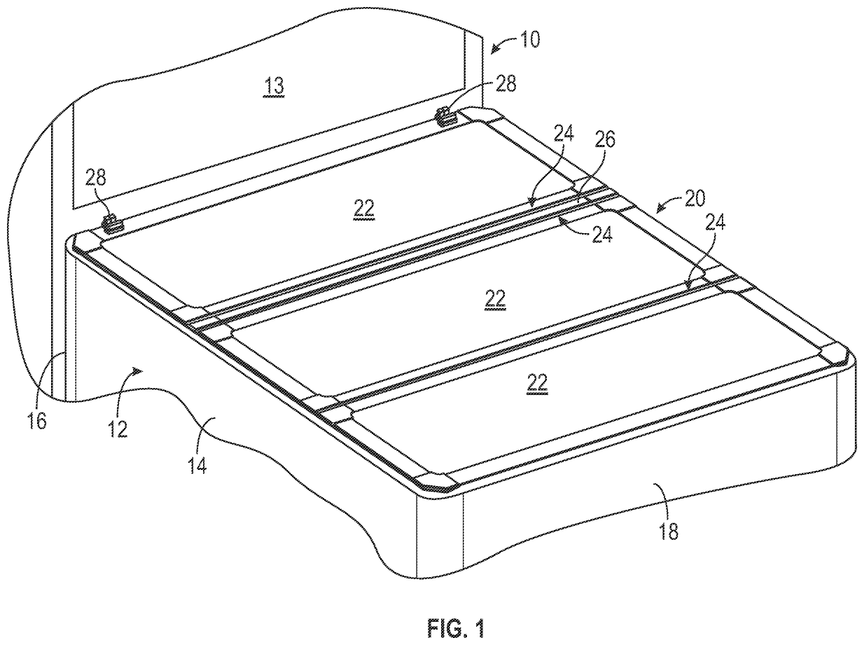

Referring now to the drawings, a foldable tonneau cover for attachment to a pickup truck 10 is generally illustrated in FIG. 1 and designated at 20. The foldable tonneau cover 20 is shown being mounted to the cargo box or bed 12 of the pickup truck 10 so as to cover or enclose the bed 12. The bed 12 is located rearward of the passenger cabin 13 (hereafter just “cab”) and includes a pair of opposed sidewalls 14 joined at their forward and reward ends by a front wall or bulkhead 16 and rear wall or tailgate 18, respectively. The tops of the sidewalls 14 define bed rails 19, and the foldable tonneau cover 20 may be mounted to or rest upon the bed rails 19.

The foldable tonneau cover 20 is shown in an extended or unfolded position where individual sections or panels 22 of the tonneau cover 20 are generally coplanar and adjacent one another so as to fully extend over and cover the bed 12. Adjacent panels 22 are connected to one another by hinge assemblies 24 and, as such, the tonneau cover 20 is foldable from the extended position to a folded position.

When folding the tonneau cover 20, the panels 22 are folded relative to one another from the tailgate 18 toward the cab 13 to uncover at least a portion of the bed 12. The rear panel 22 (the panel 22 adjacent to the tailgate 18) is first folded over and on top of the adjacent or intermediate panel 22. Next, the intermediate and rear panels 22, together, are folded over and on top of the front panel 22 (the panel adjacent to the bulkhead 16 and cab 13) forming a nested stack of the panels 22 at the front end of the bed 12 near the cab 13. To accommodate the combined thickness of the previously folded panels 22, the intermediate and front panels 22 may be connected by a pair of hinge assemblies 24 that are themselves connected to each other by a spacer 26. Buckles 28, seen in FIG. 1, may be provided to secure the folded tonneau cover 20 in the nested stack.

While illustrated as having three panels 22, it will be appreciated that the tonneau cover 20 may have more or less than three panels 22. Accordingly, the portion of the bed 12 covered by the stack of panels 22 may constitute a quarter or more of the area of the bed 12. Optionally, the stack of panels 22 may be pivoted and secured in a substantially upright position adjacent to a rear window of the cab 13, providing additional access to the bed 12 of the truck 10.

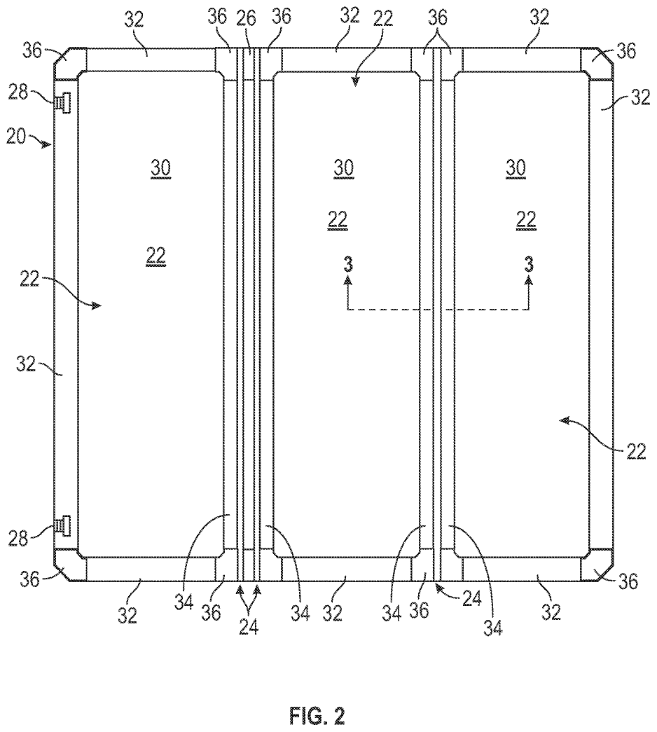

As seen in FIG. 2, the panels 22 each include a central panel member 30 that may be fortified about its perimeter by reinforcements that include edge reinforcements 32 and hinge reinforcements 34, the latter being located between adjacent panels 22 and connected to the hinge mechanisms 24, as further discussed below. The corners of the panels 22 may include corner reinforcements 36.

The edge and hinge reinforcements 32, 34 may be formed as extrusions of metal or other materials, and the corner reinforcements 36 may be formed as cast or machined pieces of metal or other materials.

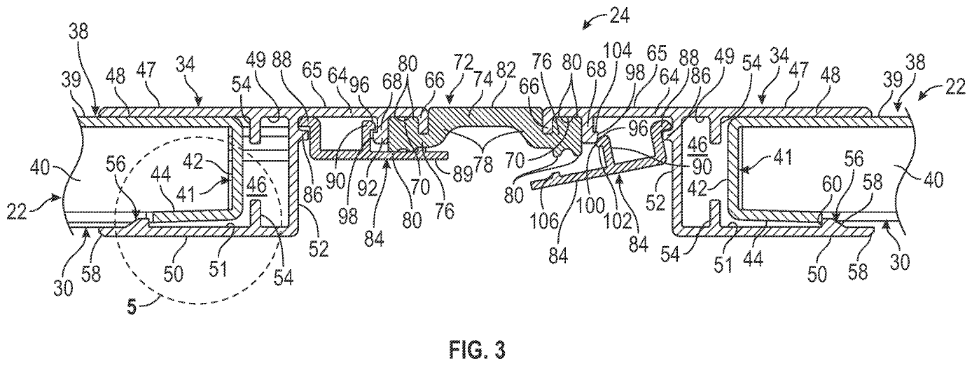

As seen in FIGS. 3, 4, and 5, the panel members 30 may each be provided with a body 38 (e.g., formed of sheet metal or other material), with a portion of the body 38 defining the upper surface 39 of the panel member 30. Ends of the body 38 that are generally adjacent to a neighboring panel 22 can comprise a returnly bent portion 41 having a generally C-shape, where a transverse leg 42 of one body 38 faces a transverse leg 42 of an adjacent body 38, such that they mirror each other. Other constructions for the panel members 30 may also be employed. For example, the panel members 30 may be formed of an outer skin that surrounds an inner core (e.g., formed of polyurethane foam or other material), as long as the ends of the body 38 of the panel members 30 are capable of securing into the corresponding hinge reinforcement 34, as discussed below.

The returnly bent portion 41 is generally formed of an end of the upper surface 39 of the panel member 30, the transverse leg 42 of the panel member 30, and a terminal leg 44 of the panel member. Specifically, in forming the returnly bent portion 41, the transverse leg 42 extends downward from the upper surface 39 of the panel member 30 and a terminal leg 44 extends generally parallel to a plane defined by the upper surface 39 of the panel member 30. While the terminal leg 44 may be parallel with the plane defined by the upper surface 39 of the panel member 30, the terminal leg 44 may be angled downward relative to the plane at an angle (α) between about one (1) degree and about five (5) degrees. Preferably, such angle (α) is about two (2) degrees (see FIG. 5).

To engage the perimeter of the panel members 30, each reinforcement 32, 34 is formed with an open ended channel 46 that receives the returnly bent portions 41 of the body 38 in a direction that is transverse to the length of the channel 46. In other words, the reinforcements 32, 34 are fitted over or pushed onto the ends of the panel members 30.

FIG. 3, and 4 further illustrate hinge reinforcements 34 fitted over adjacent returnly bent portions 41 of panel members 30 allowing for and forming a part of the hinge mechanism 24 provided therebetween. It will be appreciated that the edge reinforcements 32 are similarly fitted over the outer perimeter of the panel members 30, but without features forming part of the hinge mechanism 24.

The channel 46 of a reinforcement 32, 34 is defined by opposed upper and lower legs 48, 50 connected by an end wall 52. The upper and lower legs 48, 50 are spaced apart a distance equal to or slightly greater than the overall thickness of edge of the panel member 30 at the returnly bent portion 41 (i.e., from upper surface 39 through terminal leg 44). Provided on the interior surfaces 49, 51 of the upper and lower legs 48, 50 and extending transversely into the channel 46 are stops 54. The stops 54 limit the extent to which the panel member 30 can be pushed into the channel 46.

Further formed on the interior surface 51 of the lower leg 50, and adjacent to the terminal end 58 of lower leg 50, is a locking tab 56. The locking tab 56 includes an inclined or ramped lead-in surface 60 followed by a transverse abutment shoulder 62. For reasons discussed below, the distance between the stop 54 and locking tab 56 on the lower leg 50 is more than the length of the terminal leg 44 of the returnly bent portion 41.

During insertion of an end of the panel member 30 into one of the reinforcements 32, 34, the returnly bent portion 41 of the body 38 engages ramped lead-in surface 60 of the locking tab 56. The terminal leg 44 of the returnly bent portion 41 is sufficiently resilient to permit inward deflection of the terminal leg 44 by the locking tab 56 without permanent deformation. Because the length of terminal leg 44 is less than the distance between the stop 54 and locking tab 56, before the stop 54 is engaged by the end of the panel member 30 (e.g., by the transverse leg 42), the end of the terminal leg 44 passes over the locking tab 56 and beyond the abutment shoulder 62, where it resiliently snaps-back into its undeflected position, preventing disengagement of the reinforcement 32, 34 from the panel member 30. The engagement is therefore a press-fit, mechanically locking engagement.

Optionally, one or more seal elements, such as a foam gasket or a liquid sealant, may be provided in areas between the those portions of the hinge reinforcement 34 defining the channel 46 and those portions of panel 22 defining the returnly bent portion 41.

As so far described above, the edge and hinge reinforcements 32, 34 are similarly constructed. Each hinge reinforcement 34, however, additionally includes features allowing for attachment of the hinge assembly 24 provided between adjacent panels 22 or between a panel 22 and a spacer 26. It is noted that the spacer 26 may be constructed similarly to the panels 22 and similarly provided with edge and hinge reinforcements 32, 34.

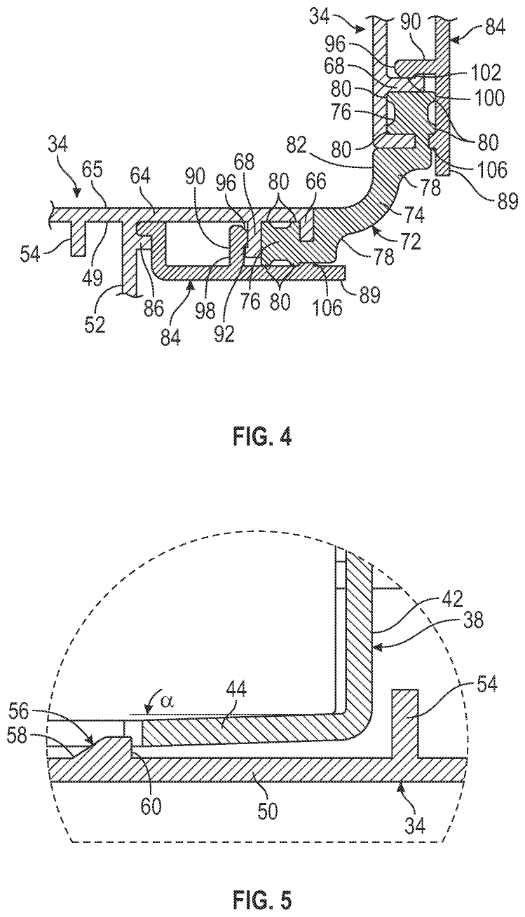

As further seen in FIGS. 3 and 4, each hinge reinforcement 34 includes an extension 64 that is opposite of and generally planar with the upper leg 48 of the reinforcement 34. The end of this extension 64 includes an end flange 66 that extends generally perpendicular to the extension 64 or generally parallel to the end wall 52. Between the end flange 66 and the end wall 52, the extension 64 additionally includes an intermediate flange 68. The intermediate flange 68 cooperates with the end flange 66 to define a retention groove 70 into which is received a portion of the hinge assembly's flexible hinge 72, as further discussed below.

The flexible hinge 72 is preferably unitarily constructed of an elastomeric material, such as rubber or a synthetic material having similar properties, and includes a central body 74, a pair of retention features 76, and a pair of webs 78. The retention features 76 are enlarged protrusions located on opposite sides of the central body 74 and are connected to the central body by the thinner webs 78. While illustrated in cross-section as being block shaped with a pair of ribs 80 on opposing sides, the retention features 76 may be formed in different shapes, including round or oval. The shape and size of the webs 78 and the central body 74 are such that when the tonneau cover 20 is unfolded and extended over the bed 12, the upper surface 82 of the central body 74 is substantially flush with the upper surface 47 of the upper leg 48 and the upper surface 65 of the extension 64 of each hinge reinforcement 34.

To secure the flexible hinge 72 to the hinge reinforcement 34, a hinge clip 84 engages with the hinge reinforcement 34 to capture the retention feature 76 in each retention groove 70. The hinge clip 84 is preferably formed as a metal extrusion and is shown in the figures in cross-section. It will be understood that the hinge clip 84 may have a length equal to the length of the hinge reinforcement 34 and extend substantially across the width of the bed 12 of the pickup truck 10. For convenience, the hinge clip 84 is described relative to the cross-sectional view of the hinge clip 84 seen in the figures. It will therefore be appreciated that the side edges of the hinge clip 84, extending along its length, may be referred to as the ends of the hinge clip 84 in connection with a description of its cross-sectional shape.

To facilitate the engagement of the hinge clip 84 with the hinge reinforcement 34, a first boss 86 is formed on the end wall 52 and protrudes in a direction toward the intermediate flange 68, while a second boss 92, a locking boss, is formed on the intermediate flange 68 and protrudes toward the end wall 52. The first boss 86 is spaced apart from lower surface of the extension 64 a distance slightly greater than the thickness of a hook 88 formed on one end of the hinge clip 84. Located between the hook 88 and an opposed free end 89 of the hinge clip 84 is a locking tab 90. The locking tab 90 extends toward the extension 64 for engagement with the locking boss 92.

By positioning the hook 88 in the space between the first boss 86 and the extension 64, a force can be applied to the free end 89 of the hinge clip 84, in the direction of the retention groove 70, to pivot the hinge clip 84 causing the locking tab 90 to engage with the locking boss 92. The locking tab 90 includes a ramp surface 96, a shoulder 100 and a locking surface 102. During this pivoting of the hinge clip 84, the ramp surface 96 of locking tab 90 engages an opposed ramp surface 98 of the locking boss 92 and the locking tab 90 is resiliently deflected. Continued pivoting of the hinge clip 84 passes the shoulder 100 of the locking tab 90 over the locking boss 92 where the locking tab 90 snaps back into its undeflected position with the locking surface 102 positioned in abutment with an opposed locking surface 104 of the locking boss 92, thereby locking the hinge clip 84 to the extension 64 of the hinge reinforcement 34 with a positive locking, snap-in retained engagement.

When the hinge clip 84 is secured to the extension 64 of the hinge reinforcement 34, the free end 89 of the hinge clip 84 extends a distance beyond the locking tab 90 whereby the free end 89 overlies the retention feature 76 of the flexible hinge 72, capturing and compressing the retention feature 76 and its ribs 80 in the retention channel 70 to provide a water resistant connection. A boss 106 may be provided on the free end 89 to further supplement the engagement with and compression of the retention feature 76 and the adjacent web 78.

Although the invention has been described with reference to certain specific embodiments incorporating the principles of the invention, one skilled in the art will readily appreciate that the invention is susceptible to modification, variation and change without departing from the true spirit and fair scope of the invention, as defined in the claims that follow. The scope of the claims should therefore not be limited by the preferred embodiments, but should be given the broadest interpretation consistent with the description as a whole. The terminology used herein is therefore intended to be understood in the nature of words of description and not words of limitation.

I/We claim:

1. A foldable tonneau cover for use in covering the bed of a pickup truck, the tonneau cover comprising:
a plurality of tonneau cover sections including at least a first tonneau cover section and a second tonneau cover section;
a hinge assembly including a flexible hinge and at least one hinge clip, the hinge clip being in a positive locking retained engagement with one of the first and second tonneau cover sections and securing the flexible hinge to said one of the first and second tonneau cover sections; and
the hinge assembly hingedly connecting the first tonneau cover section to the second tonneau cover section, whereby the first tonneau cover section is foldable relative to the second tonneau cover section so as to form a stack with the first tonneau cover section being located on top of the second tonneau cover section

2. The foldable tonneau cover according to claim 1, wherein the hinge clip captively secures the flexible hinge to said one of the first and second tonneau cover sections.

3. The foldable tonneau cover according to claim 1, wherein the flexible hinge includes a body and at least one retention feature, the retention feature being captively secured by the hinge clip to said one of the first and second tonneau cover sections spaced apart from the body.

4. The foldable tonneau cover according to claim 3, wherein the flexible hinge is of a unitary construction with the retention feature being connected to the body by a web having a reduced cross-sectional thickness relative to the body and the retention feature.

5. The foldable tonneau cover according to claim 1, wherein the first and second tonneau cover sections include reinforcement members provided along an end thereof, each the reinforcement members defining a retention groove in which a portion of the flexible hinge is received, whereby the reinforcement members are connected to the hinge assembly.

6. The foldable tonneau cover according to claim 5, wherein the reinforcement members are extrusions.

7. The foldable tonneau cover according to claim 5, wherein the hinge clip is in positive locking retained engagement with the reinforcement member.

8. The foldable tonneau cover according to claim 1, wherein the hinge clip is pivotable about a first end into the positive locking retained engagement with said one of the first and second tonneau cover sections.

9. The foldable tonneau cover according to claim 1, wherein the positive locking retained engagement of the hinge clip with said one of the first and second tonneau cover sections includes a locking tab of the hinge clip in a snap-in engagement with said one of the first and second tonneau cover sections.

10. The foldable tonneau cover according to claim 1, wherein the hinge clip includes a free end overlying a portion of the flexible hinge and captively securing the flexible hinge to said one of the first and second tonneau cover sections.

11. A tonneau cover for use with the bed of a pickup truck, the tonneau cover comprising at least one rigid panel, the rigid panel including a central panel member defining a perimeter and a plurality of reinforcement members, the reinforcement members being located along at least a portion of the perimeter of the central panel member, the reinforcement members being engaged with the central panel member in a press-fit mechanical locking engagement.

12. The tonneau cover according to claim 11, wherein each of the reinforcement members defines an open ended channel within which the central panel member is received.

13. The tonneau cover according to claim 11, wherein each of the reinforcement members includes opposed and spaced apart upper and lower legs, at one end the upper and lower legs are connected by an end wall and an opposing end the upper and lower legs define an opening into the opened ended channel of the reinforcement member.

14. The tonneau cover according to claim 13, wherein one of the upper and lower legs include a locking tab, the locking tab being provided on a surface opposing the other of the upper and lower legs.

15. The tonneau cover according to claim 14, wherein the locking tab is defined by a ramped lead-in surface followed by an abutment shoulder, whereby the locking tab is in engagement with the central panel member and forms the locking engagement between the reinforcement member and the central panel member.

16. The tonneau cover according to claim 15, wherein the central panel member includes a portion defining an edge facing in a direction away from the reinforcement member, the locking tab being in engagement with the edge.

17. The tonneau cover according to claim 11, wherein the reinforcement members are constructed as extrusions.

18. The tonneau cover according to claim 11, wherein at least a portion of the perimeter of the central panel includes a returnly bent portion generally defining a C-shape, the returnly bent portion being formed by a portion of a body defining an upper surface of the central panel member, a transverse leg extending away from the upper surface and a terminal leg extending away from the transverse leg.

19. The tonneau cover according to claim 18, wherein the terminal leg is in engagement with the reinforcing member thereby forming the locking engagement.

20. The tonneau cover according to claim 18, wherein the terminal leg resiliently extends at an angle away from a plane defined by the upper surface and is deflected during engagement with the reinforcing member thereby forming the press-fit mechanical locking engagement.
